(19) United States
(12) Patent Application Publication
(10) Pub. No.: US 2023/0401137 A1
(43) Pub. Date: Dec. 14, 2023

(54) METHOD, DEVICE, AND COMPUTER PROGRAM PRODUCT FOR PROCESSING SYSTEM LATENCY

(71) Applicant: DELL PRODUCTS L.P., Round Rock, TX (US)

(72) Inventors: Bing LIU, Tianjin (CN); Lingdong WENG, Beijing (CN); Zheng LI, Beijing (CN)

(21) Appl. No.: 17/875,202

(22) Filed: Jul. 27, 2022

(30) Foreign Application Priority Data
Jun. 9, 2022 (CN) 202210653059.5

(51) Int. Cl. G06F 11/30; G06F 11/34; G06F 11/07

(52) U.S. Cl. CPC G06F 11/3072; G06F 11/3452; G06F 11/0757

(57) ABSTRACT

Embodiments of the present disclosure relate to a method, a device, and a computer program product for processing a system latency. The method includes obtaining a group of records in a system for a group of data persistence operations of a particular type, and estimating a group of estimated latencies in the group of data persistence operations based on the group of records. Each record in the group of records includes a group of metrics for a group of states of the system within a predetermined period when each data persistence operation occurs. The method also includes determining corresponding contributions of each state in the group of states to latencies of the group of data persistence operations based on the group of records and the group of estimated latencies, and determining one or more states from the group of states based on the corresponding contributions. Embodiments of the present disclosure can identify, in a complex system environment, major factors that increase the latencies of data persistence operations and the degree of influence on the amount of latency by these factors, thereby providing a user with a targeted improvement direction.

### TECHNICAL FIELD

Embodiments of the present disclosure relate to system performance tests and, more specifically, to a method, a device, and a computer program product for processing a system latency.

### BACKGROUND

In a common operating system, a process of the system firstly writes data into a memory when processing a file. Later, when appropriate, the process calls data persistence operations of the system (e.g., using fsync functions, etc.) to flush the memory so as to synchronize updated content in the memory to a persistent storage device (e.g., disks). Furthermore, some system daemons also call (e.g., periodically) data persistence operations to synchronize data to the persistent storage device.

### SUMMARY OF THE INVENTION

Embodiments of the present disclosure provide a solution for processing a system latency.

In a first aspect of the present disclosure, a method for processing a system latency is provided, including: obtaining a group of records in a system for a group of data persistence operations of a particular type, wherein each record in the group of records comprises a group of metrics for a group of states of the system within a predetermined period when each data persistence operation occurs; estimating a group of estimated latencies of the group of data persistence operations based on the group of records; determining corresponding contributions of each state in the group of states to latencies of the group of data persistence operations based on the group of records and the group of estimated latencies; and determining one or more states from the group of states based on the corresponding contributions.

In a second aspect of the present disclosure, an electronic device is provided. The electronic device includes a processor and a memory that is coupled to the processor and has instructions stored therein. The instructions, when executed by the processor, cause the device to execute actions including: obtaining a group of records in a system for a group of data persistence operations of a particular type, wherein each record in the group of records comprises a group of metrics for a group of states of the system within a predetermined period when each data persistence operation occurs; estimating a group of estimated latencies of the group of data persistence operations based on the group of records; determining corresponding contributions of each state in the group of states to latencies of the group of data persistence operations based on the group of records and the group of estimated latencies; and determining one or more states from the group of states based on the corresponding contributions.

In a third aspect of the present disclosure, a computer program product is provided. The computer program product is tangibly stored on a computer-readable medium and includes machine-executable instructions. The machine-executable instructions, when executed, cause a machine to execute the method according to the first aspect of the present disclosure.

The Summary of the Invention part is provided to introduce a selection of concepts in a simplified manner, which will be further described in the Detailed Description below. The Summary of the Invention part is neither intended to identify key features or major features of the present disclosure, nor intended to limit the scope of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent, in which:

FIG. 1 shows a schematic diagram of an example environment in which multiple embodiments of the present disclosure can be implemented;

FIG. 2 shows an example method for processing a system latency according to some embodiments of the present disclosure;

FIG. 3 shows an example architecture for processing a system latency according to some embodiments of the present disclosure;

FIG. 4 shows an example simulation result of processing a system latency according to some embodiments of the present disclosure; and

FIG. 5 shows a schematic block diagram of a device that may be configured to implement embodiments of the present disclosure.

Throughout the drawings, the same or similar reference numerals represent the same or similar elements.

### DETAILED DESCRIPTION

The embodiments of the present disclosure will be described in more detail below with reference to the accompanying drawings. Although the drawings show some embodiments of the present disclosure, it should be understood that the present disclosure can be implemented in various forms, and should not be explained as being limited to the embodiments stated herein. Instead, these embodiments are provided for understanding the present disclosure more thoroughly and completely. It should be understood that the accompanying drawings and embodiments of the present disclosure are for illustrative purposes only, and are not intended to limit the protection scope of the present disclosure.

The term “include” and its variants as used herein mean open-ended inclusion, i.e., “including but not limited to.” The term “based on” is “based at least in part on.” The term “one embodiment” means “at least one embodiment.” The term “another embodiment” indicates “at least one additional embodiment.” Relevant definitions of other terms will be given in the description below.

Various processes of a system may call data persistence operations of the system (e.g., using fsync functions, etc.) to flush the memory so as to synchronize updated content in the memory to a persistent storage device (e.g., disks). When calling data persistence operations in the system to synchronize transaction data to a disk, multiple components of multiple system layers may be involved, e.g., an application that initiates the call, a database management subsystem that commits the transaction, a journaling file system (such as ext3 or ext4) that controls data writing, an I/O scheduler, drivers for physical interfaces, etc. In the process, the data persistence operations may have a certain latency due to the state of the components involved in the operations, other processes running in the system, etc.

When latencies of the data persistence operations in the system are too high (e.g., more than 30 seconds or even more than 50 seconds), an I/O operation may be blocked for a long time, and even downtime is caused. When the situation happens frequently, the user experience will deteriorate, and normal backup and other services may be affected. Therefore, an engineering team needs to identify specific factors that increase the latencies of data persistence operations of the system and to perform targeted actions to reduce the possibility of high latency events in the system and an average latency of the data persistence operations in the system, thereby improving the performance of the system and improving the user experience. However, the latencies of the data persistence operations are related to a number of factors in a complex system environment as the operations proceed, and the situation where a problem occurs is difficult to reproduce. This makes it difficult to investigate the latency factors of the data persistence operations and to improve the system latency in a targeted manner.

To at least partially address the above and other potential problems, embodiments of the present disclosure propose a solution for processing a system latency. The solution generates a predictor (e.g., by training a predictive model such as a machine learning model) based on various system state data associated with data persistence operations of a particular type (e.g., fsync) in a system, and the predictor may estimate the amount of latencies of the data persistence operations based on these system states. When an estimation result of the predictor is verified to be of sufficient quality, the solution analyzes (e.g., using an additive model) specific contributions of the individual system states in the estimation result of each data persistence operation by the predictor. Through the statistical characteristics of these specific contributions, the solution may determine one or more system states that increase the total amount of latencies of data persistence operations of this type the most. The solution of the present disclosure may identify, in a complex system environment, major factors that increase the latencies of data persistence operations of the system and the degree of influence on the amount of latency by these factors, and thereby can provide a user with a targeted direction for improvement of system performance.

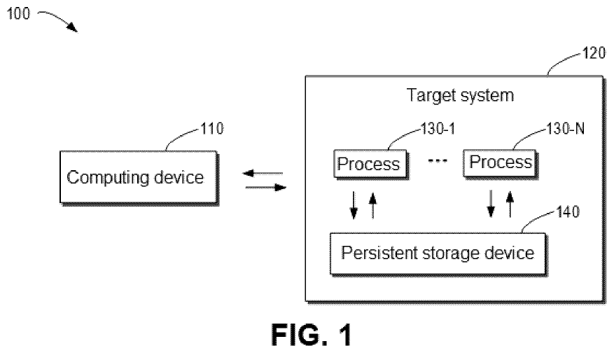

FIG. 1 shows a schematic diagram of example environment 100 in which multiple embodiments of the present disclosure can be implemented. As shown in FIG. 1, environment 100 may include computing device 110 and system 120. Although illustrated as single entities, computing device 110 and system 120 may exist and be distributed in any suitable form, and the scope of the present disclosure is not intended to be so illustrated. Furthermore, although computing device 110 and system 120 are shown as separate entities for clarity of illustration, there may be other relationships therebetween. For example, system 120 or portions of system 120 may reside on computing device 110.

Multiple processes 130-1 to 130-N(hereinafter collectively or individually referred to as process 130) may run on system 120. Process 130 may be a system daemon or workload processes of other types (such as a process of a client application). During operation of system 120, some processes 130 may terminate, and new processes 130 may be created. Process 130 may read data from persistent storage device 140 and write data to persistent storage device 140. For example, process 130 may synchronize file updates in a memory to persistent storage device 140 using a data persistence operation. It should be understood that the data persistence operation may involve multiple components (not shown) of various layers of system 120 and has a certain latency.

Computing device 110 may obtain various data about system 120, such as the latencies of the data persistence operations in system 120, and system states before and after the operation occurs. Computing device 110 may also use the method of the present disclosure to construct and verify a predictor for estimating latencies of data persistence operations based on various states of the system. Computing device 110 may also identify a major factor that increases the latencies of the data persistence operations of the system and provide a suggested action to improve the latency based on analysis of a latency estimation result of the predictor when the predictor is of sufficient quality.

The architecture and functions of example environment 100 are described for illustrative purposes only, and do not imply any limitation to the scope of the present disclosure. There may also be other devices, systems, or components that are not shown in example environment 100. Furthermore, the embodiments of the present disclosure may also be applied to other environments having different structures and/or functions.

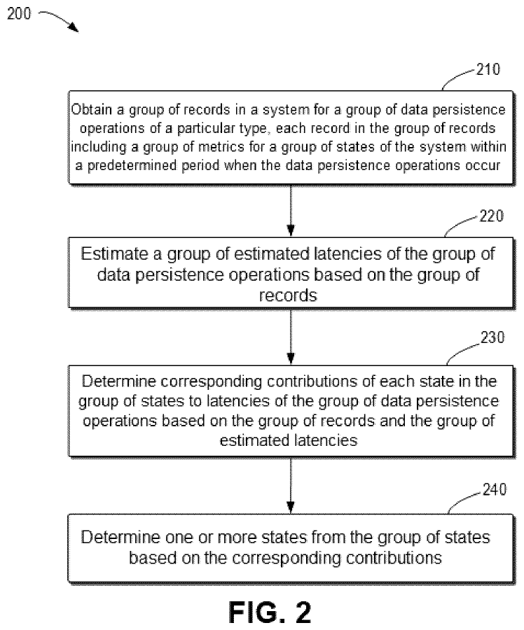

FIG. 2 shows a flow chart of example method 200 for processing a system latency according to some embodiments of the present disclosure. Example method 200 may be executed, for example, by device 110 as shown in FIG. 1. It should be understood that method 200 may also include additional actions not shown, and the scope of the present disclosure is not limited in this regard. Method 200 will be described in detail below with reference to example environment 100 in FIG. 1.

At block 210, a group of records in a system for a group of data persistence operations of a particular type are obtained. Each record in the group of records includes a group of metrics for a group of states of the system within a predetermined period when each data persistence operation occurs. For example, computing device 110 may obtain a group of records in system 120 for a group of data persistence operations of a particular type (e.g., a group of fsync operations). Each record in the group of records includes a group of metrics for a group of states of system 120 within a predetermined period when each data persistence operation occurs (e.g., N minutes before and/or after the operation occurs).

In some embodiments, a group of states may include states related to: IO stack configuration state, such as IO scheduler settings, a file system write-back strategy, a file system log strategy, and other parameters; hardware state, such as SMART information and IO errors of a hard disk; and workload mode state, such as process read/write throughput (e.g., in bytes) and system call (e.g., fsync) counts for different applications in system 120.

In some embodiments, a group of records may also include actual latencies of the group of data persistence operations. For example, computing device 110 may subsequently use the actual latencies to evaluate the quality of estimated latencies.

At block 220, a group of estimated latencies of the group of data persistence operations are estimated based on the group of records. For example, computing device 110 may estimate a group of estimated latencies of the corresponding group of data persistence operations based on the group of records (obtained at block 210) about system 120. In some embodiments, computing device 110 may use a trained predictor to generate an estimated latency for a data persistence operation of system 120. For example, computing device 110 may train and verify a machine learning model based on historical records of system 120 or a system similar to system 120, and use a machine model that has been verified to be of sufficient quality as a predictor. In some embodiments, computing device 110 may use the group of records as a training set for training a model. Computing device 110 may train and verify the model in any suitable manner in the relevant art.

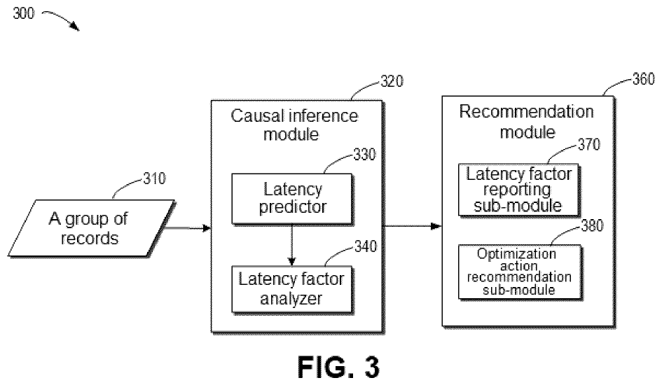

At block 230, corresponding contributions of each state in the group of states to latencies of the group of data persistence operations are determined based on the group of records and the group of estimated latencies. For example, computing device 110 may determine corresponding contributions of each state in the group of states to latencies of the group of data persistence operations based on the group of records about system 120 as described above and the corresponding group of estimated latencies. In the case where the estimated latencies (e.g., generated by the trained predictor) are of sufficient quality, the estimated latencies well reflect the situation of the actual latencies, and thus the contributions also well reflect the degree of influence on the actual latencies of the data persistence operations of system 120 by these states. For example, after training a machine learning model using the group of records as previously described, computing device 110 may generate an interpreter of the model for the group of records and estimated latencies generated by the trained model for the group of records. Computing device 110 may then use the interpreter to compute a corresponding contribution of each state in the group of records to model prediction. An example of such interpreter will be described in more detail later in connection with FIG. 3.

At block 240, one or more states are determined from the group of states based on the corresponding contributions. For example, computing device 220 may determine one or more states from the group of states of system 120 based on the corresponding contributions (determined at block 230). In some embodiments, computing device 220 may determine one or more states that contribute the most based on contribution statistical information for each state of the group of data persistence operations. Thus, computing device 110 may determine the one or more states as the dominant factor that increases the latencies of the data persistence operations of system 120.

By using method 200, the computing device may identify, in a complex system environment, major factors that increase the latencies of data persistence operations of the system and the degree of influence on the amount of latency by these factors, so as to provide a user with a guidance for improvement of system performance.

FIG. 3 shows example architecture 300 for processing a system latency according to some embodiments of the present disclosure. Architecture 300 may be an example implementation of logic modules in computing device 110 for processing a system latency (e.g., the latency of a data persistence operation of system 120) with the method (e.g., method 200) described in the present disclosure. FIG. 3 will be described below with reference to example environment 100 in FIG. 1. It should be understood that other modules not shown may also be provided in device 210. Furthermore, architecture 300 is merely illustrative, and other suitable architectures capable of performing the solution described in the present disclosure may also be used.

Architecture 300 may include causal inference module 320. Computing device 110 may use causal inference module 320 to generate a group of estimated latencies based on a group of records 310 in system 120 for a group of data persistence operations of a particular type, and analyze major factors that increase the latencies of the operations of this type in system 120 based on the group of records 310 and the group of estimated latencies. In the example, each record in the group of records 310 includes a group of metrics for a group of states of the system within a predetermined period when the corresponding data persistence operation occurs, and may further include an actual latency of the data persistence operation.

Computing device 110 may obtain the group of records 310 in any suitable manner. For example, computing device 110 may monitor system 120 and generate the group of records, receive a log that records the system state from system 120, or obtain historical state data about system 120 from other devices.

Causal inference module 320 includes latency predictor 330. Latency predictor 330 may generate a group of estimated latencies for a corresponding group of data persistence operations based on the group of records 310. For example, computing device 110 may train and verify latency predictor 330 using a machine training method and based on historical records of system 120 or a system similar to system 120 until latency predictor 330 is verified to be of sufficient quality (e.g., using actual latencies of the operations) for use in estimating the estimated latencies of the data persistence operations.

In some embodiments, computing device 110 may use the group of records 310 to train latency predictor 330. In this case, latency predictor 330 obtained may well reflect the actual situation of the group of records 310. Latency factor analyzer 340 may then determine corresponding contributions of each state in the group of states to latencies of the group of data persistence operations based on the group of records 310 and the group of estimated latencies for the group of records 310.

In some other embodiments, data used by computing device 110 to train latency predictor 330 may differ, at least in part, from the group of records 310 (e.g., from an earlier period and/or from other systems different from system 120). In some such embodiments, latency predictor 330 may not be able to accurately predict the latencies of some records in the group of records 310 (e.g., causal logic reflected by the records does not appear in training data). In this case, if, in the group of estimated latencies, a difference between an estimated latency of a certain data persistence operation and an actual latency of the operation exceeds a threshold, latency factor analyzer 340 may exclude the record and estimated latency corresponding to the data persistence operation when determining the corresponding contributions based on the group of records 310 and latency estimates for the group of records 310. As such, the analysis by latency factor analyzer 340 will be more accurate. In some embodiments, computing device 110 may also use the excluded record to adjust a latency prediction model. For example, computing device 110 may add the excluded record to the training set to retrain latency predictor 330 so that latency predictor 330 may learn new situations included in the record.

In some embodiments, latency factor analyzer 340 may use an additive model to determine the corresponding contributions. For example, the additive model may be a Shapely additive interpretation (SHAP) model. SHAP is a method of interpreting machine learning model predictions by a Shapely value. The Shapely value is a concept in the field of cooperative game theory that measures the contribution of each player to a game. In the case where n players collectively obtain a reward p, the reward p is fairly distributed to each of the n players according to the individual contributions of the players, such contributions being the Shapely value. In general, when interpreting predicted values of a model, the Shapely value is an expected marginal contribution of an instance of a feature used for prediction among all possible coalitions, reflecting the influence on the prediction of the model by the feature associated therewith.

SHAP is an additive model constructed with the inspiration of the Shapely value. The model predicts a target variable y of a sample based on k features of the sample. An ith sample in a sample set is represented as xi, a j^{th} feature of the sample is represented as xᵢⱼ, a target variable predicted value of the model for the sample is represented as yᵢ, and a baseline of the model is represented as y_{base} (typically, the mean of predicted target variables for all samples is used as the baseline). Then, an interpreter ƒ of the model may be determined such that the SHAP value conforms to the following equation 1:

yᵢ=y_{base}+ƒ(xᵢ₁)+ƒ(xᵢ₂)+ . . . +ƒ(xᵢₖ) (1)

where ƒ(xᵢⱼ) is a contribution value of the j^{th} feature in the sample xᵢⱼ for the predicted value yᵢ. The feature increases the predicted value when the value is greater than 0, and reduces the predicted value when the value is less than 0. Finally, the sum of the model baseline and the contribution values of all features will be equal to the predicted value of the sample. The SHAP value may reflect the influence of each feature of each sample and whether the influence is positive or negative.

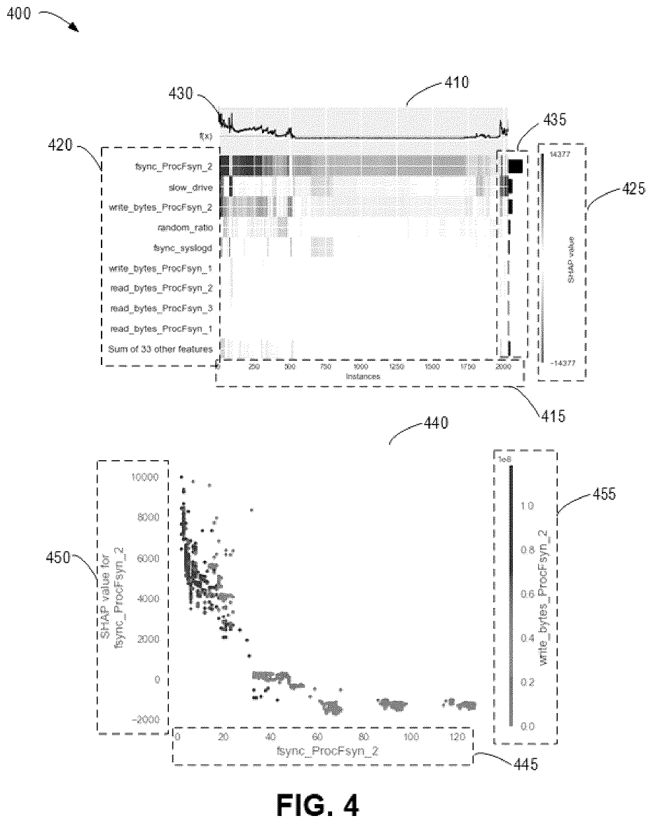

Latency factor analyzer 340 may then determine one or more states from the recorded group of states based on the determined corresponding contributions. For example, after calculating the SHAP value for each state in each sample as the corresponding contribution, latency factor analyzer 340 may calculate a statistical characteristic (e.g., a mean, etc.) of the SHAP value for each state over a group of estimations to evaluate an expected contribution of the state over the entire sample set. For example, latency factor analyzer 340 may determine one or more states for which a positive mean of the SHAP values is the highest, and infer that the one or more states cause the latency of system 120 to increase the most based on the statistical characteristic. A non-limiting example of determining the contribution based on the SHAP value and further determining one or more states will be described later in conjunction with graph 410 in FIG. 4.

Architecture 300 also includes recommendation module 360. Recommendation module 360 includes latency factor reporting sub-module 370 and optimization action recommendation sub-module 380.

Computing device 110 may use latency factor reporting sub-module 370 to generate a first report that includes an indication for one or more states identified by latency factor analyzer 340. The second report enables a system administrator to know major factors that increase the system latency. Computing device 110 may also use optimization action recommendation sub-module 380 to generate a second report. Optimization action recommendation sub-module 380 may generate the second report based on statistical characteristics of a group of metrics in a group of records for the identified one or more states. The second report includes an indication for a suggested action used to reduce the latencies of data persistence operations of a particular type in system 120. For example, optimization action recommendation sub-module 380 may generate a report that suggests checking hard disk health situation based on the identified state that increases the latency the most being an excessive I/O error rate of a hard disk. The second report provides a guidance for improvements in system performance. In some embodiments, computing device 110 may also determine a suggested action based on a mapping relationship between a group of metrics for at least a portion of states in the one or more states in the group of records. The suggested action thus generated takes the combined influence of multiple states on the latency into consideration, thereby providing a more comprehensive guidance for performance improvement. A non-limiting example of providing suggestions based on relationships of multiple states will be described later in conjunction with chart 440 in FIG. 4.

To further illustrate the advantages of example method 200, FIG. 4 shows example simulation result 400 of detecting system faults using example method 200. The example simulation may, for example, be performed by computing device 110 and is described below with reference to FIG. 1. In the example simulation, device 210 uses method 200 to identify the degree of influence on the latencies of data persistence operations by various system states of system 120. It should be understood that the specific models, tools, processes, values, etc. mentioned in describing the example simulation are merely examples for running simulation and should not be considered restrictive in any way.

In the example simulation, Linux is taken as a system environment of system 120 and fsyn is used as an instance of data persistence operation. To prepare a simulation data source, computing device 110 firstly creates 10 applications (ProcFsyn_1 to ProcFsyn_10) with different IO modes in system 120 to simulate the behavior of a running workload. Computing device 110 records multiple system states such as the number of fsync of each application, the number of read/write bytes of each application, an IO random ratio in the last n (in the example, n=2) minutes, a current IO scheduler, and a drive state as features for predicting the latencies of the data persistence operations. Additionally, in addition to the created applications, computing device 110 also records the number of fsync and the number of read/write bytes of the system processes Syslogd and Platmon as features for predicting the latency. Furthermore, computing device 110 collects fsync with the largest latency within the last n=2 minutes as an fsync sample corresponding to a feature of the same period, and uses the fsync latency of the sample as a prediction target.

Computing device 110 then constructs a prediction model based on XGBoost regression and using the recorded fsync sample set data as training data. The prediction model takes the aforementioned feature data as an input and takes the predicted maximum fsync latency within n=2 minutes as an output. Computing device 110 trains and verifies the machine learning model until the prediction result indicates that the prediction quality of the constructed model meets predetermined requirements.

Based on the trained model, computing device 110 constructs a SHAP value (i.e., a Shapely value in the simulation implementation) model interpreter. The model interpreter is configured to calculate the contribution of each feature (i.e., each recorded system state in the simulation) in the fsync sample set to each prediction result. Then, for the prediction of each sample in the fsync sample set by the predictor, computing device 110 uses the model interpreter to compute a SHAP value for each system state corresponding to the sample, where the SHAP value for each system state reflects the contribution of the system state to the estimated latency of the sample. Since the estimated latency of the verified model well reflects the actual latency, the contribution also well reflects the contribution of these features to the actual latency of the fsync operation. Then, based on statistical information of the SHAP values of the group of samples, computing device 110 may infer, from a global perspective, major factors that increase the fsync latency, and suggest long-term solutions to these factors that improve the fsync latency of the system.

For purposes of illustration, graph 410 shows a summary illustration of SHAP values generated by computing device 110 for all fsync samples in the simulation experiment. Each unit of the horizontal axis “Instances” represents an instance sample, and each unit of the vertical axis represents a collected system state, as illustrated by horizontal axis 415 and vertical axis 420. As shown in legend 425, the grayscale of each small rectangle in graph 410 indicates a SHAP value of a system state of a sample corresponding to the position. Furthermore, uppermost curve 430 of graph 410 indicates a latency estimation value for the corresponding sample by the prediction model.

Bar graph 435 to the right of graph 410 indicates the SHAP value statistics of the corresponding system states performed by computing device 110 for all samples. From this statistics, computing device 110 may infer, from a global perspective, that the top three factors that increase the latency of system 120 are the fsync number of a process of application ProcFsyn_2 (indicated by “fsync_ProcFsyn_2”), the health status of a driver (indicated by “slow_drive”), and the number of write bytes of a process of application ProcFsyn_2 (indicated by “write_bytes_ProcFsyn_2”). Computing device 110 may then generate a report indicating these factors to a user.

Computing device 110 may further identify, based on the above results, that both the fsync number and the number of write bytes of the process of application ProcFsyn_2 have a large influence on the latency, and further analyze how these two states are associated with each other to learn the internal logic of the application. Based on this analysis, computing device 110 may then provide further reports to indicate suggestions to improve the latency.

For purposes of illustration, chart 440 shows an interaction graph reflecting a relationship between the two states described above of the process of ProcFsyn_2. The interaction graph shows the correlation of the two states in contributing SHAP values to the latency prediction. Each point in chart 440 represents a sample. The coordinate of horizontal axis 445 represents the state “fsync_ProcFsyn_2” of the sample at the coordinate, and the coordinate of vertical axis 450 “SHAP value for fsync_ProcFsyn_2” represents a SHAP value of the state “fsync_ProcFsyn_2” of the sample at the position. Furthermore, as shown in legend 455, the grayscale for each sample represents the number of write bytes of the process of ProcFsyn_2 of the sample.

As illustrated by chart 440, computing device 110 may draw the following conclusion based on the relationship between the two states: when the ProcFsyn_2 write pressure is high, as the number of fsync is smaller, the fsync latency of system 120 may be severely degraded (i.e., the latency is increased). Based on this conclusion, computing device 110 may infer that the key to improving the fsync latency of system 120 is how to reduce the write pressure of the application ProcFsyn_2. In conjunction with other important factors that affect the latency, computing device 110 may generate the following suggested actions from a long-term perspective to improve the fsync latency of system 120: focusing on and improving the health situation of a driver, and optimizing the write pressure of the application ProcFsyn_2.

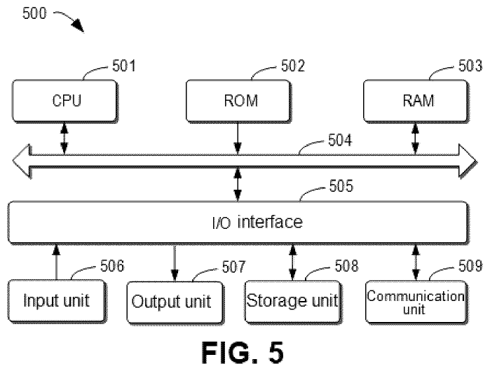

FIG. 5 shows a schematic block diagram of device 500 that may be configured to implement embodiments of the present disclosure. Device 500 may be the device or apparatus described in the embodiments of the present disclosure. As shown in FIG. 5, device 500 includes central processing unit (CPU) 501 which may perform various appropriate actions and processing according to computer program instructions stored in read-only memory (ROM) 502 or computer program instructions loaded from storage unit 508 to random access memory (RAM) 503. Various programs and data required for operations of device 500 may also be stored in RAM 503. CPU 501, ROM 502, and RAM 503 are connected to each other through bus 504. Input/output (I/O) interface 505 is also connected to bus 504. Although not shown in FIG. 5, device 500 may also include a co-processor.

A plurality of components in device 500 are connected to I/O interface 505, including: input unit 506, such as a keyboard and a mouse; output unit 507, such as various types of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

The various methods or processes described above may be performed by processing unit 501. For example, in some embodiments, the method may be implemented as a computer software program that is tangibly included in a machine-readable medium, such as storage unit 508. In some embodiments, part of or all the computer program may be loaded and/or installed to device 500 via ROM 502 and/or communication unit 509. When the computer program is loaded into RAM 503 and executed by CPU 501, one or more steps or actions of the methods or processes described above may be executed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The foregoing description is illustrative rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed here.

The listing of claims will replace all prior versions, and listings, of claims in the application:

1. A method for processing a system latency, comprising:
obtaining a group of records in a system for a group of data persistence operations of a particular type, wherein each record in the group of records comprises a group of metrics for a group of states of the system within a predetermined period when each data persistence operation occurs;
estimating a group of estimated latencies in the group of data persistence operations based on the group of records;
determining corresponding contributions of each state in the group of states to latencies of the group of data persistence operations based on the group of records and the group of estimated latencies; and
determining one or more states from the group of states based on the corresponding contributions.

2. The method according to claim 1, further comprising:
generating a first report, wherein the first report comprises an indication for the one or more states.

3. The method according to claim 2, further comprising:
generating a second report based on statistical characteristics of a group of metrics for the one or more states in the group of records, the second report comprising an indication for a suggested action used to reduce latencies of data persistence operations of the particular type in the system.

4. The method according to claim 3, further comprising:
determining the suggested action based on a mapping relationship between a group of metrics for at least a portion of states in the one or more states in the group of records.

5. The method according to claim 1, wherein determining the corresponding contributions comprises:
generating the corresponding contributions in such a manner that a mean of the sum of contributions of a group of metrics for each record in the group of records and the group of estimated latencies is equal to an estimated latency of the record.

6. The method according to claim 1, wherein the group of records further comprises actual latencies of the group of data persistence operations, and the method further comprises:
in response to a difference between a first estimated latency of a first data persistence operation in the group of estimated latencies and a first actual latency of the first data persistence operation exceeding a threshold, excluding a first record corresponding to the first data persistence operation and the first estimated latency when determining the corresponding contributions.

7. The method according to claim 6, wherein generating a group of estimated latencies comprises generating the group of estimated latencies using a trained predictor, and the method further comprises:
adjusting the trained predictor using the first record.

8. An electronic device, comprising:
a processor; and
a memory coupled to the processor having instructions stored therein which, when executed by the processor, cause the processor to perform actions, the actions comprising:
obtaining a group of records in a system for a group of data persistence operations of a particular type, wherein each record in the group of records comprises a group of metrics for a group of states of the system within a predetermined period when each data persistence operation occurs;
estimating a group of estimated latencies of the group of data persistence operations based on the group of records;
determining corresponding contributions of each state in the group of states to latencies of the group of data persistence operations based on the group of records and the group of estimated latencies; and
determining one or more states from the group of states based on the corresponding contributions.

9. The device according to claim 8, wherein the actions further comprise:
generating a first report, wherein the first report comprises an indication for the one or more states.

10. The device according to claim 9, wherein the actions further comprise:
generating a second report based on statistical characteristics of a group of metrics for the one or more states in the group of records, the second report comprising an indication for a suggested action used to reduce latencies of data persistence operations of the particular type in the system.

11. The device according to claim 10, wherein the actions further comprise:
determining the suggested action based on a mapping relationship between a group of metrics for at least a portion of states in the one or more states in the group of records.

12. The device according to claim 8, wherein determining the corresponding contributions comprises:
generating the corresponding contributions in such a manner that a mean of the sum of contributions of a group of metrics for each record in the group of records and the group of estimated latencies is equal to an estimated latency of the record.

13. The device according to claim 8, wherein the group of records further comprises actual latencies of the group of data persistence operations, and the actions further comprise:
in response to a difference between a first estimated latency of a first data persistence operation in the group of estimated latencies and a first actual latency of the first data persistence operation exceeding a threshold, excluding a first record corresponding to the first data persistence operation and the first estimated latency when determining the corresponding contributions.

14. The device according to claim 13, wherein generating a group of estimated latencies comprises generating the group of estimated latencies using a trained predictor, and the actions further comprise:
adjusting the trained predictor using the first record.

15. A non-transitory computer-readable medium having instructions stored therein, which when executed, by a processor, cause the processor to perform actions, the actions comprising:
obtaining a group of records in a system for a group of data persistence operations of a particular type, wherein each record in the group of records comprises a group of metrics for a group of states of the system within a predetermined period when each data persistence operation occurs;
estimating a group of estimated latencies in the group of data persistence operations based on the group of records:
determining corresponding contributions of each state in the group of states to latencies of the group of data persistence operations based on the group of records and the group of estimated latencies; and
determining one or more states from the group of states based on the corresponding contributions.

16. The computer-readable medium according to claim 15, wherein the actions further comprise:
generating a first report, wherein the first report comprises an indication for the one or more states.

17. The computer-readable medium according to claim 16, wherein the actions further comprise:
generating a second report based on statistical characteristics of a group of metrics for the one or more states in the group of records, the second report comprising an indication for a suggested action used to reduce latencies of data persistence operations of the particular type in the system.

18. The computer-readable medium according to claim 17, wherein the actions further comprise:
determining the suggested action based on a mapping relationship between a group of metrics for at least a portion of states in the one or more states in the group of records.

19. The computer-readable medium according to claim 15, wherein determining the corresponding contributions comprises:
generating the corresponding contributions in such a manner that a mean of the sum of contributions of a group of metrics for each record in the group of records and the group of estimated latencies is equal to an estimated latency of the record.

20. The computer-readable medium according to claim 15, wherein the group of records further comprises actual latencies of the group of data persistence operations, and the method further comprises:
in response to a difference between a first estimated latency of a first data persistence operation in the group of estimated latencies and a first actual latency of the first data persistence operation exceeding a threshold, excluding a first record corresponding to the first data persistence operation and the first estimated latency when determining the corresponding contributions.
